(19) United States
(12) Patent Application Publication
(10) Pub. No.: US 2024/0334955 A1
(43) Pub. Date: Oct. 10, 2024

(54) POPCORN MAKING ASSEMBLY AND METHOD

(71) Applicant: David Haskins, San Diego, CA (US)

(72) Inventor: David Haskins, San Diego, CA (US)

(21) Appl. No.: 18/131,561

(22) Filed: Apr. 6, 2023

(51) Int. Cl. A23L 7/187; A47J 27/00; A47J 36/32

(52) U.S. Cl. CPC A23L 7/187; A47J 27/004; A47J 36/321

(57) ABSTRACT

A popcorn making assembly and method for heating a removable container having a cover includes a housing. The housing is flared adjacent to a top of the housing to define a receptacle. A bowl is removably positioned within the receptacle of the housing. The bowl contains corn kernels, wherein the corn kernels are heatable to produce popcorn when the bowl is heated. A cover is coupled to the bowl and retains the corn kernels within the bowl when the cover is coupled to the bowl. A heater is coupled to the housing and is actuated to produce and emit heat from the housing onto the bowl positioned within the receptacle. A switch is electrically coupled to the heater and is engaged to actuate the heater.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to popcorn maker and more particularly pertains to a new popcorn maker for heating a removable container having a cover.

### (2) Description of Related Art Including Information Disclosed Under 37 CFR 1.97 and 1.98

The prior art relates to popcorn makers and includes a variety of popcorn makers heating corn kernels to produce popcorn. Known prior art does not allow a popcorn maker being able to heat a container having a cover to secure corn kernels within the container and the container is removable from the popcorn maker.

### BRIEF SUMMARY OF THE INVENTION

An embodiment of the disclosure meets the needs presented above by generally comprising a housing including a bottom wall and a perimeter wall coupled to and extending upwardly from the bottom wall. The housing is flared adjacent to a top of the housing to define a receptacle. A bowl is removably positioned within the receptacle of the housing and comprises a thermally conductive material being heatable. The bowl is configured for containing corn kernels, wherein the corn kernels are heatable to produce popcorn when the bowl is heated. A cover is couplable to the bowl and is configured for retaining the corn kernels within the bowl when the cover is coupled to the bowl. A heater is coupled to the housing and is actuated to produce and emit heat from the housing onto the bowl positioned within the receptacle. A switch is coupled to the housing and is electrically coupled to the heater. The switch is engageable to actuate the heater. A circuit board is electrically coupled to the actuator and to the heater. A power cord is electrically coupled to circuit board, wherein the power cord is configured to receive electricity from an electrical outlet.

Another embodiment of the disclosure comprises a method including the steps of providing a bowl and a housing. Corn kernels are placed within the bowl prior to coupling a cover to the bowl. The bowl is positioned within a receptacle of the housing and a heater of the housing is actuated thereafter. The cover is removed from the bowl when popcorn is produced from the corn kernels. The bowl is removed from the receptacle and the heater of the housing is turned off thereafter.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top perspective view of a popcorn making assembly and method according to an embodiment of the disclosure.

FIG. 2 is a cross-sectional view of an embodiment of the disclosure taken along Line 2-2 of FIG. 1.

FIG. 3 is a detail view of an embodiment of the disclosure.

FIG. 4 is a cross-sectional view of an embodiment of the disclosure taken along Line 4-4 of FIG. 3.

FIG. 5 is a detail view of an embodiment of the disclosure.

FIG. 6 is a flowchart view of an embodiment of the disclosure.

FIG. 7 is a block diagram view of an embodiment of the disclosure.

### DETAILED DESCRIPTION OF THE INVENTION

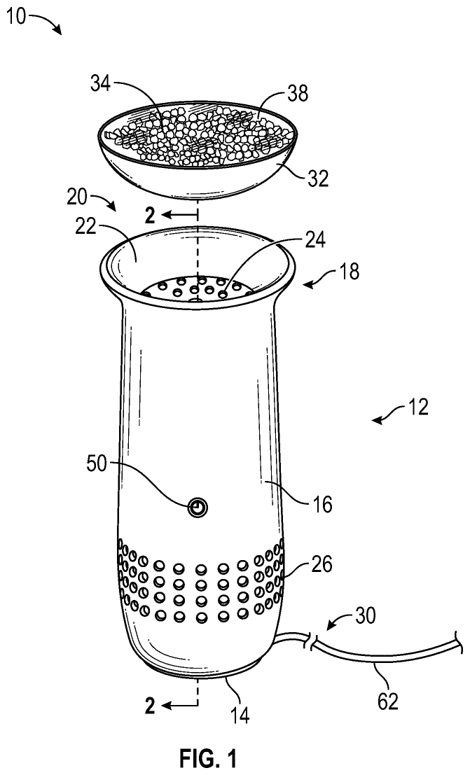

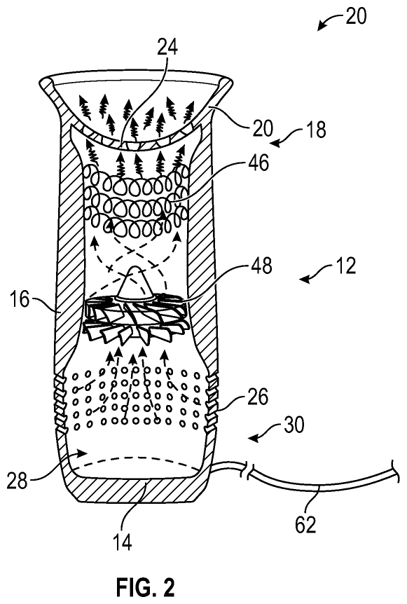

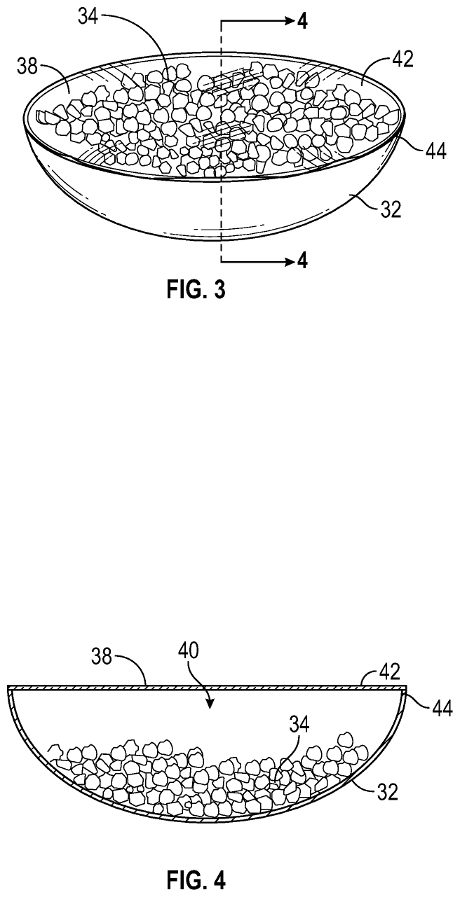

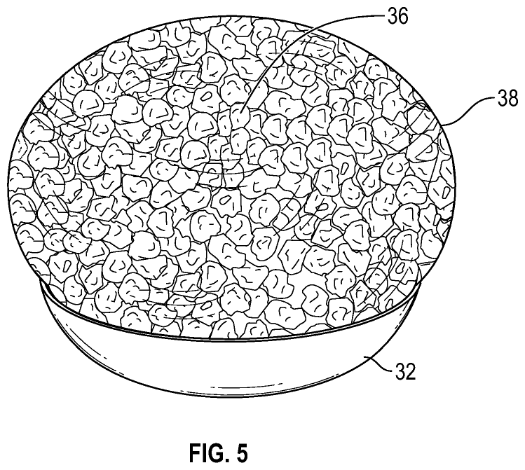

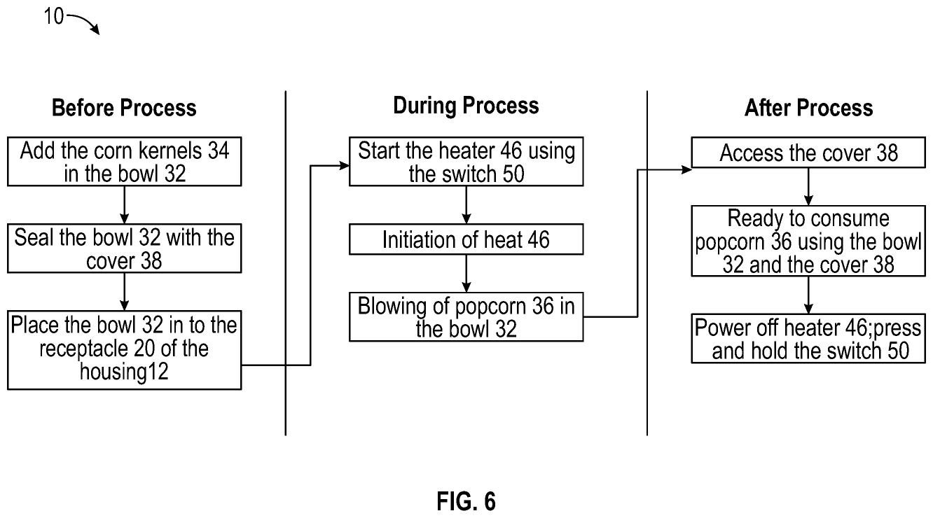

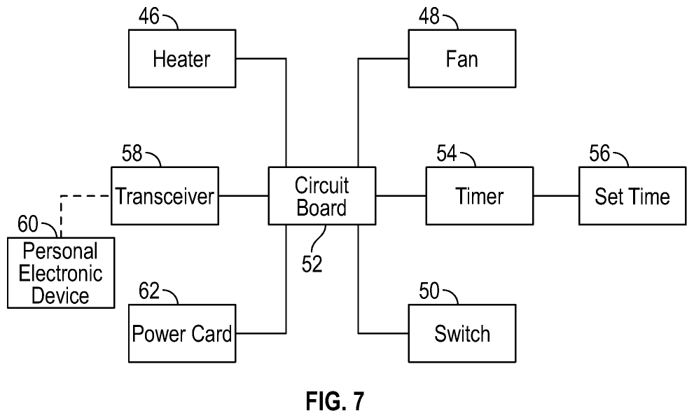

With reference now to the drawings, and in particular to FIGS. 1 through 7 thereof, a new popcorn maker embodying the principles and concepts of an embodiment of the disclosure and generally designated by the reference numeral 10 will be described.

As best illustrated in FIGS. 1 through 7, the popcorn making assembly and method 10 generally comprises a housing 12 including a bottom wall 14 and a perimeter wall 16 coupled to and extending upwardly from the bottom wall 14. The housing 12 is flared adjacent to a top 18 of the housing 12 to define a receptacle 20. The receptacle 20 typically comprises an annular wall 22 coupled to a center wall 24, and the center wall 24 may be concavely arcutate. The center wall 24 and a bottom half 26 of the perimeter wall 16 are perforated, wherein an interior space 28 of the housing 12 is ventilated from a bottom 30 to the top 18 of the housing 12.

A bowl 32 is removably positioned within the receptacle 20 of the housing 12. The bowl 32 normally comprises a thermally conductive material being heatable. The bowl 32 is configured for containing corn kernels 34, wherein the corn kernels 34 are heatable to produce popcorn 36 when the bowl 32 is heated. A cover 38 is coupled to the bowl 32 and is configured for retaining the corn kernels 34 within the bowl 32 when the cover 38 is coupled to the bowl 32. The cover 38 may be expandable, wherein the cover expands outwardly to increase a containing space 40 of the bowl 12 as the bowl 12 is heated. A boundary edge 42 of the cover 38 is coupled to a top edge 44 of the bowl 32 to form a seal between the cover 38 and the bowl 32. The cover 38 may be manufactured to keep the containing space 40 of the bowl 32 airtight when the cover 38 is sealed to the bowl 32.

A heater 46 is coupled to the housing 12 and is actuated to produce and emit heat from the housing 12 onto the bowl 32 positioned within the receptacle 20. The heater 46 normally comprises a plurality of electric coils positioned proximate to the receptacle 20 of the housing 12. A fan 48 may be positioned beneath the heater 46 within the interior space 28 of the housing 12 and be actuated to draw air in through the perforated bottom half 26 of the perimeter wall 16 towards the perforated center wall 24 of the receptacle 20, wherein the fan 48 blows heated air upwardly from the heater 46 through the perforated center wall 24 at the top of the housing 12 when the heater 46 is actuated.

A switch 50 is coupled to the housing 12 and is electrically coupled to the heater 46. The switch 50 is engageable to actuate the heater 46. The switch 50 may comprise a push button switch positioned on an exterior surface of the perimeter wall 16, wherein a user may press the push button switch to actuate the heater 46. A circuit board 52 is electrically coupled to the switch and to the heater 46. The circuit board 52 is normally positioned within the housing 12.

A timer 54 is electrically couplable to the circuit board 52 to be in electric communication with the switch 50. The timer 54 is actuated to count a set time 56 when the heater 46 is turned on by the switch 50, wherein the heater 46 is turned off after the timer 54 counts the set time 56. A transceiver 58 is electrically couplable to the circuit board 52 to be in electric communication with the heater 46. The transceiver 58 is configured for being in wireless communication with a personal electronic device 60 such as a mobile phone, wherein the transceiver 58 sends a signal configured to be received by the personal electronic device 60. A power cord 62 is electrically coupled to circuit board 52, wherein the power cord 62 is configured to receive electricity from an electrical outlet. The power cord 62 normally extends outwardly from an exterior surface of the perimeter wall 16.

In use, the bowl 32 holding the corn kernels 34 with the cover 38 coupled thereto is positioned within the receptacle 20 of the housing 12. The heater 46 of the housing 12 is actuated to heat the bowl 32, wherein the corn kernels 34 are heated within the bowl 32 to produce popcorn 36. The cover 38 is removed from the bowl 32 when popcorn 36 is produced from the corn kernels 34. The bowl 32 is removed from the receptacle 20 and the heater 46 of the housing 12 is turned off thereafter. The transceiver 58 may be actuated to wirelessly communicate with the personal electronic device 60 to notify a person when the heater 46 is turned off.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A popcorn making assembly comprising:
a housing including a bottom wall and a perimeter wall coupled to and extending upwardly from said bottom wall, said housing being flared adjacent to a top of said housing to define a receptacle;
a bowl being removably positioned within said receptacle of said housing, said bowl comprising a thermally conductive material being heatable, said bowl being configured for containing corn kernels, wherein said corn kernels are heatable to produce popcorn when said bowl is heated;
a cover being couplable to said bowl, said cover being configured for retaining the corn kernels within said bowl when said cover is coupled to said bowl;
a heater being coupled to said housing, said heater being actuated to produce and emit heat from said housing onto said bowl positioned within said receptacle;
a switch being coupled to said housing and being electrically coupled to said heater, said switch being engageable to actuate said heater;
a circuit board being electrically coupled to said switch and to said heater; and
a power cord being electrically coupled to circuit board, wherein said power cord is configured to receive electricity from an electrical outlet.

2. The popcorn making assembly of claim 1, wherein said receptacle comprises an annular wall coupled to a center wall, said center wall being concavely arcutate, said center wall and a bottom half of said perimeter wall being perforated, wherein an interior space of said housing is ventilated from a bottom to said top of said housing.

3. The popcorn making assembly of claim 1, wherein a boundary edge of said cover is coupled to a top edge of said bowl to form a seal between said cover and said bowl.

4. The popcorn making assembly of claim 1, wherein said heater comprises a plurality of electric coils positioned proximate to said receptacle of said housing.

5. The popcorn making assembly of claim 1, further including a fan being positioned beneath said heater within said interior space of said housing and being actuated to draw air in through said perforated bottom half of said perimeter wall towards said perforated center wall of said receptacle, wherein said fan blows heated air upwardly from said heater through the perforacted center wall at the top of the housing when said heater is actuated.

6. The popcorn making assembly of claim 1, wherein said switch comprises a push button switch positioned on an exterior surface of said perimeter wall.

7. The popcorn making assembly of claim 1, wherein said circuit board is positioned within said housing.

8. The popcorn making assembly of claim 1, further including a timer being electrically couplable to said circuit board to be in electric communication with said switch, said timer being actuated to count a set time when said heater is turned on by said switch, wherein said heater is turned off after said timer counts said set time.

9. The popcorn making assembly of claim 1, further including a transceiver being electrically couplable to said circuit board to be in electric communication with said heater, said transceiver being configured for being in wireless communication with a personal electronic device, wherein said transceiver sends a signal configured to be received by the personal electronic device.

10. The popcorn making assembly of claim 1, wherein said power cord extends outwardly from an exterior surface of said perimeter wall.

11. A popcorn making assembly comprising:
a housing including a bottom wall and a perimeter wall coupled to and extending upwardly from said bottom wall, said housing being flared adjacent to a top of said housing to define a receptacle, said receptacle comprising an annular wall coupled to a center wall, said center wall being concavely arcutate, said center wall and a bottom half of said perimeter wall being perforated, wherein an interior space of said housing is ventilated from a bottom to said top of said housing;
a bowl being removably positioned within said receptacle of said housing, said bowl comprising a thermally conductive material being heatable, said bowl being configured for containing corn kernels, wherein said corn kernels are heatable to produce popcorn when said bowl is heated;
a cover being couplable to said bowl, said cover being configured for retaining the corn kernels within said bowl when said cover is coupled to said bowl, a boundary edge of said cover being coupled to a top edge of said bowl to form a seal between said cover and said bowl;
a heater being coupled to said housing, said heater being actuated to produce and emit heat from said housing onto said bowl positioned within said receptacle, said heater comprising a plurality of electric coils positioned proximate to said receptacle of said housing;
a fan being positioned beneath said heater within said interior space of said housing and being actuated to draw air in through said perforated bottom half of said perimeter wall towards said perforated center wall of said receptacle, wherein said fan blows heated air upwardly from said heater through the perforacted center wall at the top of the housing when said heater is actuated;
a switch being coupled to said housing and being electrically coupled to said heater, said switch being engageable to actuate said heater, said switch comprising a push button switch positioned on an exterior surface of said perimeter wall;
a circuit board being electrically coupled to said switch and to said heater, said circuit board being positioned within said housing;
a timer being electrically couplable to said circuit board to be in electric communication with said switch, said timer being actuated to count a set time when said heater is turned on by said switch, wherein said heater is turned off after said timer counts said set time;
a transceiver being electrically couplable to said circuit board to be in electric communication with said heater, said transceiver being configured for being in wireless communication with a personal electronic device, wherein said transceiver sends a signal configured to be received by the personal electronic device; and
a power cord being electrically coupled to circuit board, wherein said power cord is configured to receive electricity from an electrical outlet, said power cord extending outwardly from an exterior surface of said perimeter wall.

12. A method for making popcorn with a popcorn making assembly comprising the steps of:
providing a bowl and a housing;
placing corn kernels within said bowl;
coupling a cover to said bowl;
positioning said bowl within a receptacle of said housing;
actuating a heater of said housing;
removing said cover from said bowl when popcorn is produced from the corn kernels;
removing said bowl from said receptacle; and
powering off said heater of said housing.
